(19) United States
(12) Patent Application Publication
(10) Pub. No.: US 2024/0069350 A1
(43) Pub. Date: Feb. 29, 2024

(54) IMAGE LIGHT GUIDE WITH FLEXIBLE SUBSTRATE

(71) Applicant: Vuzix Corporation, West Henrietta, NY (US)

(72) Inventor: Robert J. Schultz, Victor, NY (US)

(21) Appl. No.: 18/271,208

(22) PCT Filed: Jan. 7, 2022
(86) PCT No.: PCT/US2022/011675

§ 371 Date: Jul. 6, 2023

Related U.S. Application Data
(60) Provisional application No. 63/134,646, filed on Jan. 7, 2021.

(51) Int. Cl. G02B 27/01; F21V 8/00; G02B 27/42

(52) U.S. Cl. CPC G02B 27/0172; G02B 6/0016; G02B 6/0035; G02B 6/0065; G02B 27/0176; G02B 27/4205; G02B 27/0081

(57) ABSTRACT

An image light guide for conveying a virtual image, including a waveguide, an in-coupling diffractive optic operable to direct image-bearing light beams into the waveguide, and an outcoupling diffractive optic operable to direct the image-bearing light beams from the waveguide toward an eyebox, wherein the waveguide is configured to flex about one or more points thereof.

### TECHNICAL FIELD

The present disclosure relates generally to image light guides, and more particularly to image light guides utilizing a flexible substrate material and protective polymer coatings to enable the bending and damage resistance thereof.

### BACKGROUND

Head-Mounted Displays (HMDs) and virtual image near-eye display systems are being developed for a range of diverse uses, including military, commercial, industrial, fire-fighting, and entertainment applications. For many of these applications, there is value in forming a virtual image that can be visually superimposed over the real-world image that lies in the field of view of the user. An optical image light guide may convey image-bearing light to a viewer in a narrow space for directing the virtual image to the viewer's pupil and enabling this superimposition function.

Although conventional image light guide arrangements have seen a significant reduction in bulk, weight, and overall cost of near-eye display optics, further improvements are needed, especially in the area of safety. As virtual image near-eye display systems become more minimalistic, usage is expected to increase dramatically, leading to an increase in the potential for operators to be involved in hazardous conditions. As such, eye safety becomes a major concern. While rigidity of a glass substrate in an image light guide is preferred for stability, such substrates may be brittle and inflexible. The present disclosure provides for a virtual near-eye display system having a flexible waveguide.

### SUMMARY

The present disclosure provides for a wearable display apparatus including an optics module that supports the display apparatus adjacent to a viewer's head. In a first exemplary embodiment, a projector fitted within the optics module generates angularly related beams of image-bearing light projected along a path. An image light guide is coupled to a forward section of the optics module in the path of the image-bearing light beams. The image light guide includes a waveguide formed from a transparent optical material, an in-coupling diffractive optic formed on the waveguide and disposed to direct the image-bearing light beams into the waveguide, and an out-coupling diffractive optic disposed to direct the image-bearing light beams out of the waveguide. The out-coupling diffractive optic is disposed to expand the respective image-bearing light beams in at least one dimension and to form a virtual image within a viewer eyebox.

In an exemplary embodiment, the waveguide is formed of a flexible, thermo-chemically treated material and protrudes from an optics module. The protruding portion of flexible substrate that is not connected to the optics module is operable to bend along its length by zero to twenty-degrees or more. In an embodiment, the waveguide system includes a protective layer to prevent scratches and increase containment of waveguide sharding debris.

### BRIEF DESCRIPTION OF THE DRAWINGS

The accompanying drawings are incorporated herein as part of the specification. The drawings described herein illustrate embodiments of the presently disclosed subject matter and are illustrative of selected principles and teachings of the present disclosure. However, the drawings do not illustrate all possible implementations of the presently disclosed subject matter and are not intended to limit the scope of the present disclosure in any way.

FIG. 1 is a schematic perspective view of an image light guide of a near-eye display system.

FIG. 2 is a top view of a right-eye near-eye display system according to an exemplary embodiment of the presently disclosed subject matter.

FIG. 3 is a top view of a left-eye near-eye display system according to an exemplary embodiment of the presently disclosed subject matter.

FIG. 4 is a front elevational view of the near-eye display system according to FIG. 2.

FIG. 5 is a perspective view of the near-eye display system according to FIG. 2 without the electronics module.

FIG. 6A is a top view of the near-eye display system according to FIG. 5.

FIG. 6B is a top view of the near-eye display system according to FIG. 6A showing flexure of the waveguide.

FIG. 6C is a top view of the near-eye display system according to FIG. 6A showing flexure of the waveguide.

FIG. 7A is a schematic diagram showing a simplified cross-sectional view of an image light guide according to an exemplary embodiment of the presently disclosed subject matter.

FIG. 7B is a schematic diagram showing a simplified cross-sectional view of the image light guide according to FIG. 7A including protective layers.

FIG. 8A is a schematic diagram showing a simplified cross-sectional view of a stacked waveguide system according to an exemplary embodiment of the presently disclosed subject matter.

FIG. 8B is a schematic diagram showing a simplified cross-sectional view of a portion of the stacked waveguide system according to FIG. 8A.

FIG. 8C is a schematic diagram showing a simplified cross-sectional view of a near-eye display according to an exemplary embodiment of the presently disclosed subject matter.

FIG. 8D is a schematic diagram showing a simplified cross-sectional view of the near-eye display according to FIG. 8C with flexure of the stacked waveguide system.

FIG. 9A is a schematic diagram showing a simplified cross-sectional view of surface relief gratings fixed to a substrate.

FIG. 9B is a schematic diagram showing a simplified cross-sectional view of surface relief gratings fixed to a flexed substrate.

FIG. 10 is a schematic diagram showing a simplified cross-sectional view of surface relief gratings according to an exemplary embodiment of the presently disclosed subject matter.

FIG. 11A is a schematic diagram showing a simplified cross-sectional view of surface relief gratings according to another exemplary embodiment of the presently disclosed subject matter.

FIG. 11B is a schematic diagram showing a simplified cross-sectional view of surface relief gratings according to FIG. 11A in a flexed position.

### DETAILED DESCRIPTION

It is to be understood that the invention may assume various alternative orientations and step sequences, except where expressly specified to the contrary. It is also to be understood that the specific assemblies and systems illustrated in the attached drawings and described in the following specification are simply exemplary embodiments of the inventive concepts defined herein. Hence, specific dimensions, directions, or other physical characteristics relating to the embodiments disclosed are not to be considered as limiting, unless expressly stated otherwise. Also, although they may not be, like elements in various embodiments described herein may be commonly referred to with like reference numerals within this section of the application.

Where used herein, the terms “first”, “second”, and so on, do not necessarily denote any ordinal, sequential, or priority relation, but are simply used to more clearly distinguish one element or set of elements from another, unless specified otherwise.

Where used herein, the terms “viewer”, “operator”, “observer”, and “user” are considered equivalents and refer to the person or system viewing images via a device having an image light guide.

Where used herein the term “set” refers to a non-empty set, as the concept of a collection of elements or members of a set is widely understood in elementary mathematics. Where used herein, the term “subset”, unless otherwise explicitly stated, refers to a non-empty proper subset, that is, to a subset of the larger set, having one or more members. For a set S, a subset may comprise the complete set S. A “proper subset” of set S, however, is strictly contained in set S and excludes at least one member of set S.

Where used herein, the terms “coupled,” “coupler,” or “coupling,” in the context of optics, refer to a connection by which light travels from one optical medium or device to another optical medium or device.

Where used herein, the term “exemplary” is meant to be “an example of”, and is not intended to suggest any preferred or ideal embodiment.

As used herein, the term “beam expansion” is intended to mean replication of a beam via multiple encounters with an optical element to provide exit pupil expansion in one or more directions. Similarly, as used herein, to “expand” a beam, or a portion of a beam, is intended to mean replication of a beam via multiple encounters with an optical element to provide exit pupil expansion in one or more directions.

HMDs are developed for a range of diverse uses, including military, commercial, industrial, fire-fighting, and entertainment applications. An HMD is operable to form a virtual color image that can be visually superimposed over the real-world image that lies in the field of view of the HMD user. Optically transparent flat parallel plate waveguides, also called planar waveguides, convey image-bearing light generated by a polychromatic, or monochromatic, projector system to the HMD user. The planar waveguides convey the image-bearing light in a narrow space to direct the image to the HMD user's pupil and enable the superposition of the virtual image over the real-world image that lies in the field of view of the HMD user.

In such conventional image light guides, collimated, relatively angularly encoded light beams from a polychromatic or monochromatic image source are optically coupled into an optically transparent planar waveguide assembly by an input coupling optic, such as an in-coupling diffractive optic, which can be mounted or formed on a surface of the parallel plate planar waveguide or disposed within the waveguide. Such diffractive optics can be formed as, but are not limited to, diffraction gratings or holographic optical elements. For example, the diffraction grating can be formed as a surface relief grating. After propagating along the planar waveguide, the diffracted color image-bearing light can be directed out of the planar waveguide by a similar output optic, such as an out-coupling diffractive optic, which may be arranged to provide pupil expansion along one or more dimensions of an eyebox E. In addition, one or more intermediate optics, such as a diffraction grating which may be referred to as a turning grating, may be positioned along the waveguide optically between the input and output optics to provide pupil expansion in one or more dimensions of the virtual image. The image-bearing light output from the parallel plate planar waveguide provides an expanded eyebox for the viewer.

An optical system, such as an HMD, can produce a virtual image. In contrast to methods for forming a real image, a virtual image is not formed on a display surface. That is, if a display surface were positioned at the perceived location of a virtual image, no image would be formed on that surface. Virtual image display has a number of inherent advantages for augmented reality presentation. For example, the apparent size of a virtual image is not limited by the size or location of a display surface. Additionally, the source object for a virtual image may be small; for example, a magnifying glass provides a virtual image of an object. In comparison with systems that project a real image, a more realistic viewing experience can be provided by forming a virtual image that appears to be some distance away. Providing a virtual image also obviates the need to compensate for screen artifacts, as may be necessary when projecting a real image.

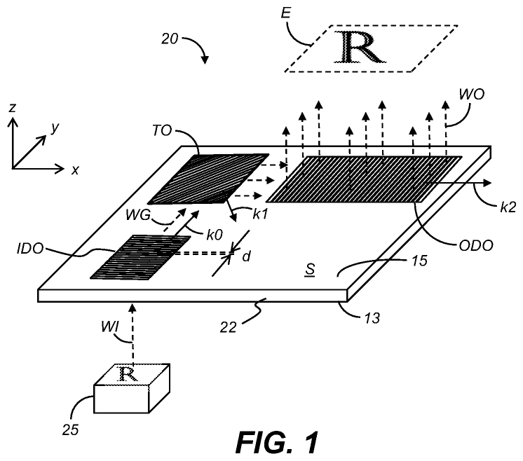

The perspective view of FIG. 1 shows an image light guide 20 that is arranged for expanding the eyebox E in two dimensions, i.e., along both x- and y-axes of the intended image. To achieve a second dimension of beam expansion, the in-coupling diffractive optic IDO having a grating vector k0 is oriented to diffract a portion of the image-bearing light WG toward an intermediate optic TO having a grating vector k1. The intermediate optic TO is oriented to diffract a portion of the image-bearing light WG in a reflective mode toward the out-coupling diffractive optic ODO. Only a portion of the image bearing light WG is diffracted by each of multiple encounters with the intermediate diffractive optic TO, thereby laterally expanding the eyebox E via replication of the angularly related beams of the image-bearing light WG approaching the out-coupling diffractive optic ODO. The intermediate optic TO may instead comprise a reflector array as described in US 2021/0215941 A1, incorporated herein by reference in its entirety. The intermediate optic TO redirects the image bearing light WG toward the outcoupling diffractive optic ODO for longitudinally expanding eyebox E via replication of the angularly related beams of the image-bearing light WG in a second dimension before exiting the planar waveguide 22 as the image-bearing light WO. Grating vectors, such as the depicted grating vectors k0, k1, and k2, extend in a direction that is normal to the diffractive features (e.g., grooves, lines, or rulings) of the diffractive optics and have a magnitude inverse to the period or pitch d (i.e., the on-center distance between grooves) of the diffractive optics IDO, TO, and ODO. The in-coupling diffractive optic IDO, the intermediate optic TO, and the out-coupling diffractive optic ODO may each have a different period or pitch d.

As illustrated in FIG. 1, the in-coupling diffractive optic IDO receives the incoming image-bearing light WI containing a set of angularly related beams corresponding to individual pixels or equivalent locations within an image generated by an image source 25. The image source 25, operable to generate a full range of angularly encoded beams for producing a virtual image, may be, but is not limited to, a real display together with focusing optics, a beam scanner for more directly setting the angles of the beams, or a combination such as a one-dimensional real display used with a scanner. The image light guide 20 outputs an expanded set of angularly related beams in two dimensions of the eyebox by providing multiple encounters of the image-bearing light WG with both the intermediate diffractive optic TO and the out-coupling diffractive optic ODO in different orientations. In the given orientation of the planar waveguide 22, the intermediate optic TO provides exit pupil expansion in the y-axis direction, and the out-coupling diffractive optic ODO provides a similar exit pupil expansion in the x-axis direction. The reflectivity characteristics and respective periods d of the in-coupling diffractive optic IDO, the out-coupling diffractive optic ODO, and the intermediate optic TO, together with the orientations of their respective grating vectors, provide for exit pupil expansion in two dimensions while preserving the intended relationships among the angularly related beams of the image-bearing light WI that are output from the image light guide 20 as the image-bearing light WO.

While the image-bearing light WI input into the image light guide 20 is encoded into a different set of angularly related beams by the in-coupling diffractive optic IDO, the information required to reconstruct the image is preserved by accounting for the systematic effects of the in-coupling diffractive optic IDO. The intermediate optic TO, located in an optically intermediate position between the in-coupling and out-coupling diffractive optics IDO, ODO, is typically arranged so that it does not induce any significant change on the encoding of the image-bearing light WG. The out-coupling diffractive optic ODO is typically arranged in a symmetric fashion with respect to the in-coupling diffractive optic IDO, e.g., including diffractive features sharing the same period. Similarly, the period of the intermediate optic TO also typically matches the common period of the in-coupling and out-coupling diffractive optics IDO, ODO. As illustrated in FIG. 1, the grating vector k1 of the intermediate optic TO is shown oriented at forty-five degrees (45°) with respect to the other grating vectors k0, k2 (all as undirected line segments). However, in another embodiment, the grating vector k1 of the intermediate optic TO may be oriented at sixty degrees (60°) to the grating vectors k0, k2 of the in-coupling and out-coupling diffractive optics IDO, ODO in such a way that the image-bearing light WG is turned one-hundred-twenty degrees (120°). By orienting the grating vector k1 of the intermediate optic TO at sixty degrees (60°) with respect to the grating vectors k0, k2 of both the in-coupling and out-coupling diffractive optics IDO, ODO, the grating vectors k0, k2 of the in-coupling and out-coupling diffractive optics IDO, ODO are also oriented at sixty degrees (60°) with respect to each other. Basing the grating vector magnitudes on the common pitch of the intermediate optic TO and the in-coupling and out-coupling diffractive optics IDO, ODO, the three grating vectors k0, k1, k2 form an equilateral triangle, and sum to a zero magnitude, which avoids asymmetric effects that could introduce unwanted aberrations including chromatic dispersion.

The image-bearing light WI that is diffracted into the planar waveguide 22 is effectively encoded by the in-coupling optic, whether the in-coupling optic uses gratings, holograms, prisms, mirrors, or some other mechanism. Any reflection, refraction, and/or diffraction of light that takes place at the input must be correspondingly decoded by the output in order to re-form the virtual image that is presented to the viewer. The intermediate optic TO, placed at an optically intermediate position between the in-coupling and out-coupling diffractive optics IDO, ODO, is typically designed and oriented so that it does not induce any change on the encoded light. The out-coupling diffractive optic ODO decodes the image-bearing light WG into its original or desired form of angularly related beams that have been expanded to fill the eyebox E. In a broader sense, whether any symmetries are maintained or not among the turning optic TO and the in-coupling and out-coupling diffractive optics IDO, ODO or whether or not any change to the encoding of the angularly related beams of the image-bearing light WI takes place along the planar waveguide 22, the intermediate optic TO and the in-coupling and out-coupling diffractive optics IDO, ODO are related so that the image-bearing light WO that is output from the planar waveguide 22 preserves or otherwise maintains the original or desired form of the image bearing light WI for producing the intended virtual image.

The letter “R” represents the orientation of the virtual image that is visible to the viewer whose eye is in the eyebox E. As shown, the orientation of the letter “R” in the represented virtual image matches the orientation of the letter “R” as encoded by the image-bearing light WI. A change in the rotation about the z-axis or angular orientation of incoming image-bearing light WI with respect to the x-y plane causes a corresponding symmetric change in rotation or angular orientation of ouTOoing light from out-coupling diffractive optic ODO. From the aspect of image orientation, the intermediate optic TO acts as a type of optical relay, providing expansion of the exit pupil along one axis (e.g., along the y-axis). The out-coupling diffractive optic ODO further expands the exit pupil along another axis (e.g., along the x-axis) while maintaining the original orientation of the virtual image encoded by the image-bearing light WI. In embodiment, where the intermediate optic TO is a diffraction grating, the intermediate optic TO is typically a slanted or square grating or, alternately, can be a blazed grating and is typically arranged on the front or back surfaces 13, 15 of the planar waveguide 22.

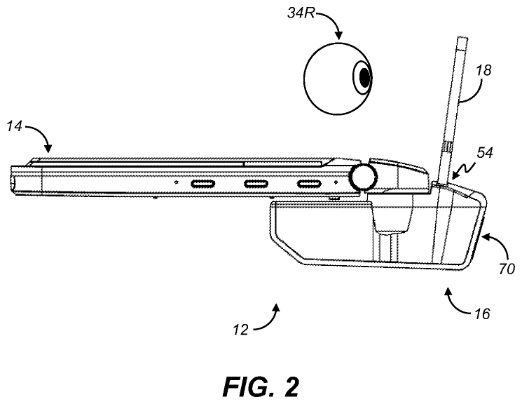

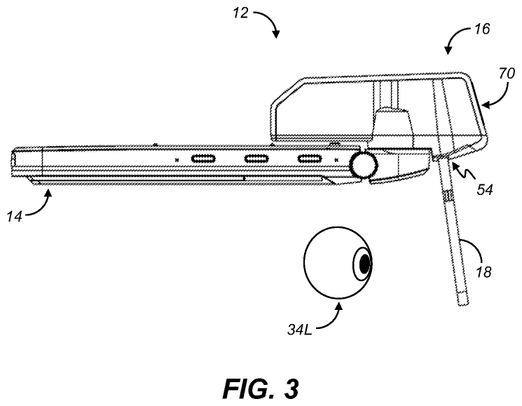

In the description that follows, the optical path components, spacing, and constraints are described with reference to the right eye 34R of an observer as represented in FIG. 2. As illustrated in FIG. 3, the same characteristics and constraints can optionally apply for the left eye, with parallel components and corresponding changes in component positioning. Further, certain embodiments of the present disclosure consider providing optical path components to the left and right eyes simultaneously. Therefore, the HMD encompasses both a monocular optical imaging apparatus and a binocular imaging apparatus.

As illustrated in FIG. 2, in an embodiment, a near-eye display system 12 includes an electronics module 14, an optics module 16 in electrical connection with, and coupled to, the electronics module 14, and a planar waveguide 18 coupled with the optics module 16. In an embodiment, a mount 54 is configured to mechanically secure the planar waveguide 18 with the optics module 16. The optics module 16 is operable to convey image-bearing light to the eye 34R via the planar waveguide 18. In an embodiment, the optics module 16 includes a projector operable to generate a full range of angularly encoded image-bearing light beams.

In an embodiment, the projector is a color field sequential projector system operable to pulse image-bearing light of red, green and blue wavelength ranges onto a digital light modulator/micro-mirror array (a “DLP”) or a liquid crystal on silicon (“LCOS”) display.

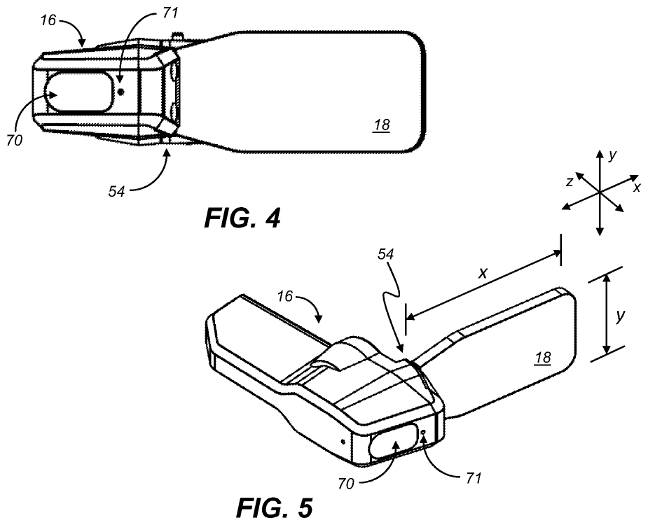

In an embodiment, the near-eye display system 12 houses an integrated camera 70. The camera 70 may include a camera flash and/or a light source 71 as shown in FIGS. 4 and 5.

As illustrated in FIGS. 4 and 5, the planar waveguide 18 may extend out from the waveguide mount 54 by a ratio of 1.5:1 or more along its x-axis, wherein the waveguide mount 54 connects to less than 50% of the planar waveguide 18 periphery. In this embodiment, the majority of the planar waveguide 18 is suspended in front of the eye 34R. In an embodiment, the optics module 16 may be detached from the electronic module 14.

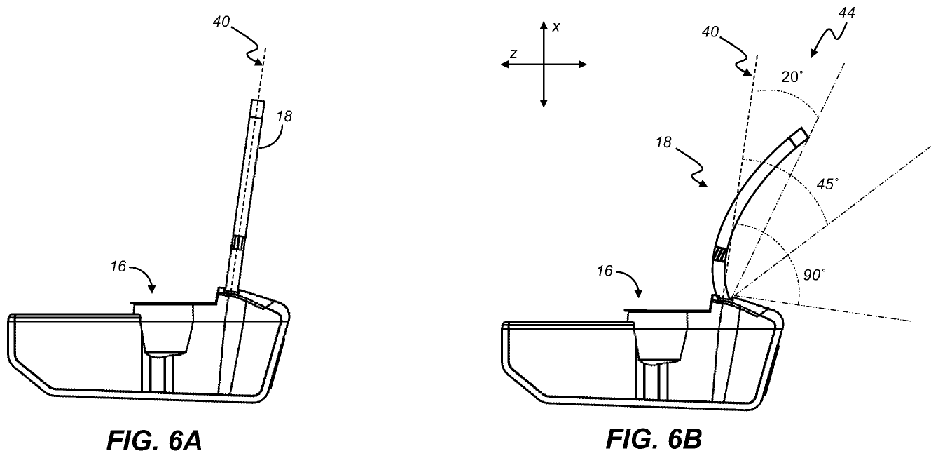

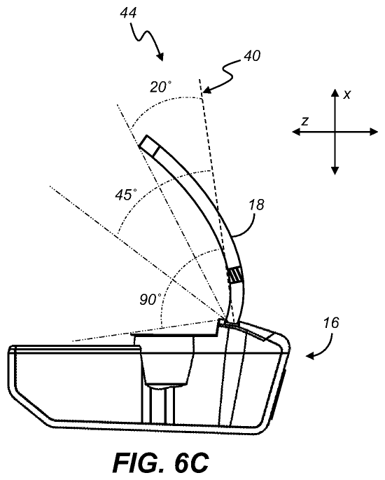

Referring now to FIG. 6A, in an embodiment, the planar waveguide 18 has a flexure of zero degrees (0°) when unmolested by physical stressors. In other words, in a rest state, the planar waveguide 18 does not generally include any curvature about the x-, y-, or z-axis. In the rest state orientation, the planar waveguide 18 includes a longitudinal axis 40.

As described further below, the planar waveguide 18 may be constructed from one or more substrates including one or more flexible materials forming a substrate system. The substrate system of the planar waveguide 18 may include materials such as, but not limited to, polymer coatings, treated glass, and polyester films. Such films may include varieties in the class comparable to, or exceeding in tensile resiliency of, Melinex® 339, Corning@Willow Glass Substrates, and PLEXIGLAS® Optical 0Z024. Referring now to FIGS. 6A, 6B, and 6C, the properties of these substrate materials, including the substrate, polymer coating layer, treated glass layer, adhesive deposition, and the like enable the planar waveguide 18 to bend along the x-axis in the z-axis direction before breaking. In an embodiment, the planar waveguide 18 may flex along the y-axis before breaking. In yet another embodiment, the planar waveguide 18 may flex along the z-axis before breaking. In yet another embodiment, the planar waveguide 18 may flex along more than one axis. For example, the planar waveguide 18 may form a bend having a rotational angle (e.g., by twisting in multiple directions).

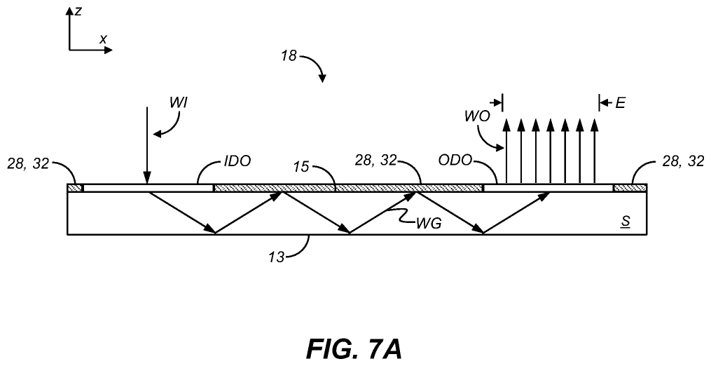

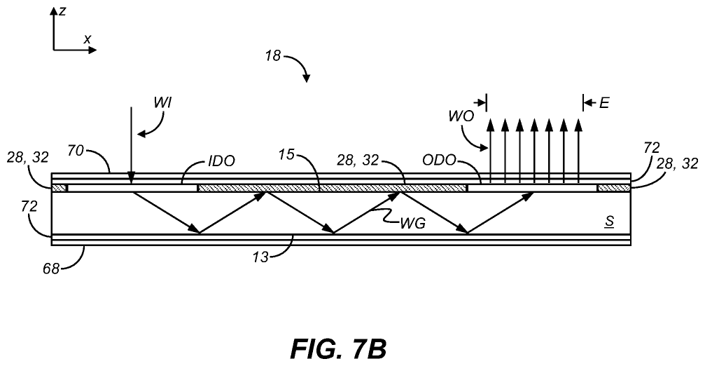

Referring now to FIG. 7A, in an embodiment, the planar waveguide 18 includes a substrate S. The substrate S includes an alkali-containing glass material compound that has been strengthened through a thermo-chemical process. In the thermo-chemical process, the substrate S is immersed in a molten salt bath at a temperature range lower than the melting point of the glass material compound during which an ionic exchange transpires. During the molten salt bath, sodium ions diffuse out of the substrate S and are replaced with potassium ions. This ionic exchange results in a surface compression of the glass material compound of the substrate S, which reduces the likelihood of sharding events. The compressed glass material compound of the substrate S is then suspended one or more additional times in heated steel immersion tanks containing molten salt to further increase surface hardness.

FIG. 7A is a schematic diagram showing a simplified cross-sectional view of the planar waveguide 18 including the substrate S having generally parallel surfaces 13, 15. In an embodiment, a coating 28 is located on the substrate surface 15. In an embodiment, the surface 15 is located proximal to one of the wearer's eyes 34R, 34L (see FIGS. 2 and 3) during use, and the surface 13 is located opposite the surface 15. In another embodiment, the coating 28 is located on the substrate surface 13. In still another embodiment, the coating 28 is located on both surfaces 13, 15 of the substrate S. In an embodiment, an in-coupling diffractive optic IDO and/or an out-coupling diffractive optic ODO are located in the substrate coating 28.

For example, substrate coating 28 includes a transparent polymeric material that is operable to transmit incoming image bearing light WI. Surface adhesion is maximized when polymeric depositions react with the substrate surface 13, 15 and present the maximum number of accessible sites with appropriate surface energies. To promote adhesion between the substrate coating 28 and substrate S, substrate S may be treated with an adhesive promotor 32, including, but not limited to, a hydrophobic silane based mono-layer or substituent multilayer, UV light exposure, thermal processing, or another method effecting total coverage.

Referring now to FIGS. 6B and 6C, the substrate S, substrate coating 28, and any additional treatment layer, if any, form a substrate system of the waveguide 18, which is operable to flex, for example, along the x-axis (i.e., in the z-axis direction) with a flexure arc 44 of zero to twenty degrees (0°-20°) without becoming delaminated. As shown in FIG. 6C, for example, waveguide 18 is flexed along the x-axis by a flexure arc 44 of approximately twenty degrees (20°) without becoming delaminated. In another embodiment, an acceptable flexure range along an axis without delamination of the substrate system of the waveguide 18 may be up to approximately ten degrees (10°). In yet another embodiment, an acceptable flexure range along an axis without delamination of the substrate system of the waveguide 18 may be zero to five degrees (0°-5°). In another embodiment, an acceptable flexure range along an axis without delamination of the substrate system of the waveguide 18 may be zero to fifteen degrees (0°-15°). In an embodiment, the waveguide 18 may include flexure ranges along more than one axis without delamination, by twisting or otherwise applying force along multiple directions, wherein the waveguide 18 is flexed along each axis ranging from zero to twenty degrees (0°-20°).

An acceptable flexure range, without breakage, of the substrate coating 28 or additional treatment layer may exceed twenty degrees (20°). “Acceptable flexure” and “flexure arc” mean the amount of flexure of the substrate system of the waveguide 18 within which the waveguide 18 is operable to return to its unflexed position after flexure without breakage or delamination.

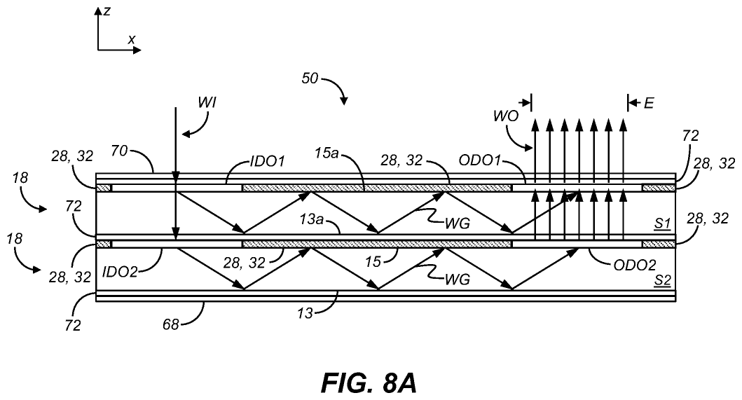

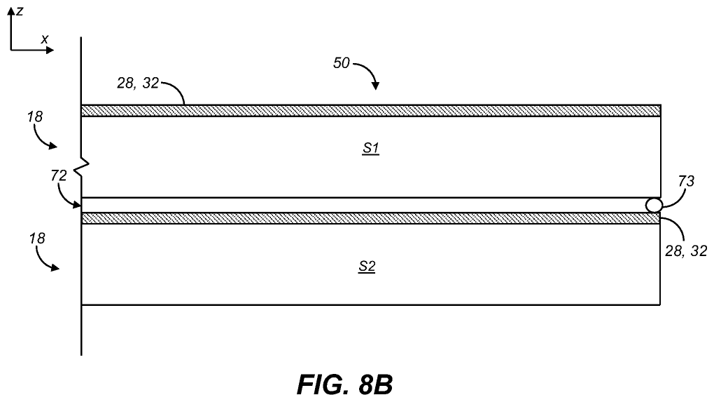

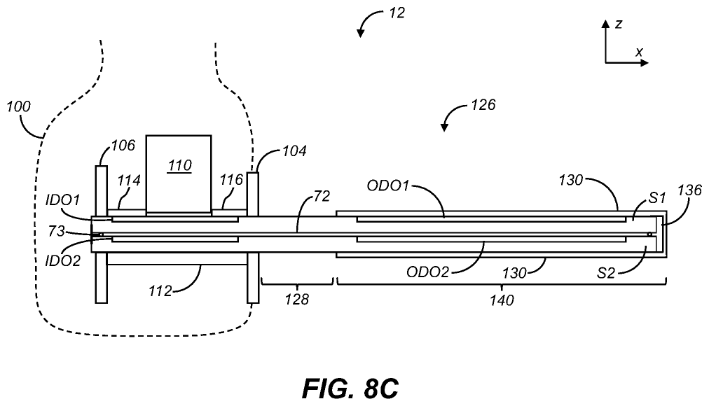

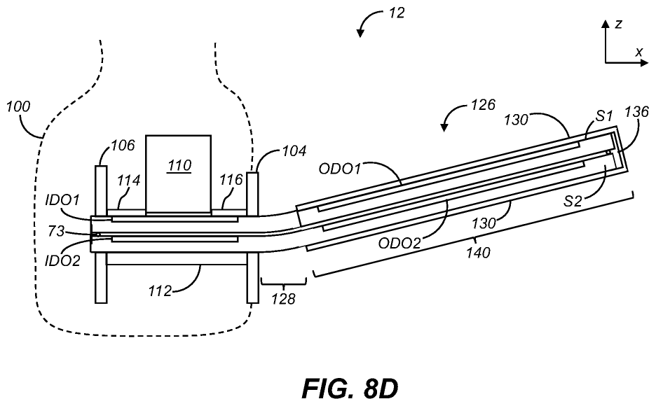

In an embodiment, one or more protective layers may be applied to the substrate S or between multiple substrates (see FIG. 8A), and the like. That is, in an embodiment, a waveguide 18 having one or more protective layers applied to the substrate S has the flexure ranges described above. In another embodiment, a stacked set of planar waveguides 50 has the flexure ranges along one or more axis as described above.

As illustrated in FIGS. 7A and 7B, the in-coupling diffractive optic IDO may be a transmissive type diffraction grating arranged on inner plane parallel surface 15 of the substrate S. However, the in-coupling diffractive optic IDO may alternately be a volume hologram or other holographic diffraction element, or other type of diffractive optical component operable to in-couple image-bearing light WI into the waveguide 18. The in-coupling diffractive optic IDO can be located on the outer plane parallel surface 13 or inner plane parallel surface 15 of substrate S and can be of a transmissive or reflective type in a combination that is a function of the direction from which the incoming image-bearing light WI approaches substrate S.

When used as a part of a virtual display system, the in-coupling diffractive optic IDO couples the image-bearing light WI from a real image source into the substrate S of the planar waveguide 18. Any real image or image dimension is first converted into an array of overlapping angularly related beams encoding the different pixel positions within an image for presentation to the in-coupling diffractive optic IDO. The image-bearing light WI is diffracted and at least a portion of the image-bearing light WI is thereby redirected by the in-coupling diffractive optic IDO into the planar waveguide 18 as image-bearing light WG for further propagation along the planar waveguide 18 by Total Internal Reflection (“TIR”).

Although diffracted into a generally more condensed range of angularly related beams in keeping with the boundaries set by TIR, the image-bearing light WG preserves the image information in an encoded form. The out-coupling diffractive optic ODO receives the encoded image-bearing light WG and diffracts at least a portion of the image-bearing light WG out of the planar waveguide 18 as the image-bearing light WO toward the intended location of a viewer's eye. Generally, the out-coupling diffractive optic ODO is designed symmetrically with respect to the in-coupling diffractive optic IDO to restore the original angular relationships of the image-bearing light WI among outputted angularly related beams of the image-bearing light WO. However, to increase one direction of overlap among the angularly related beams in the eyebox E within which the virtual image can be seen, the out-coupling diffractive optic ODO is arranged to encounter the image-bearing light WG multiple times and to diffract only a portion of the image-bearing light WG on each encounter. The multiple encounters along the length of the out-coupling optic in the direction of propagation have the effect of expanding one direction of the eyebox within which the image-bearing light beams overlap. The expanded eyebox E decreases sensitivity to the position of a viewer's eye for viewing the virtual image.

The out-coupling diffractive optic ODO is shown as a transmissive type diffraction grating arranged on the inner surface 15 of the substrate S. However, similar to the in-coupling diffractive optic IDO, the out-coupling diffractive optic ODO can be located on the outer surface 13 or the inner surface 15 of the substrate S, or both, and be of a transmissive or reflective type in a combination that depends upon the direction through which the image bearing light WG is intended to exit the substrate S.

FIG. 7B illustrates an air gap 72 which may be 0.1 mm in thickness, or vary according to the embodiment. The air gap 72 enables TIR to proceed efficiently within substrate S. Air gap 72 borders substrate S and/or the coating 28 along both the outer surface 13 and the inner surface 15. In an embodiment, the air gap 72 may be a transparent material with the same index of refraction as air. The transparent material may include, but is not limited to, mesoporous aerogel made of silica, silica nanorods, organic polymers, and the like. In another embodiment, as illustrated in FIG. 8B, the air gap 72 comprises air or a gaseous fluid maintained by a low shrinkage, low durometer, material 73 operable to flex with the waveguide 18 assembly.

As illustrated in FIG. 8A, the air gap 72 may exist between the substrates S1, S2 of a waveguide stack 50. In an embodiment, the waveguide stack 50 includes two or more waveguides 18. In an embodiment, as illustrated in FIG. 8B, the air gap 72 is maintained by a low shrinkage, low durometer material 73 located about the perimeter of the system, and operable to provide for the independent movement of substrates S1, S2. In an embodiment, the low durometer material 73 may function as a seal about the perimeter of the substrates S1, S2 against the intrusion of environmental contaminants between the substrates S1, S2.

Referring now to FIG. 7B, a first protective layer 68 and a second protective layer 70 may be coupled with the substrate S over the substrate coating 28 and the air gap 72. In an embodiment, the protective layers 68, 70 comprise a fully transparent polymer, allowing image bearing light WI, WO to pass in and out of the substrate S without significant impact to the function of the waveguide 18.

Upon impact to, or excessive stress upon, the substrate S, protective layers 68, 70 are operable to increase containment of a possible sharding action of the substrate S. For example, a polymeric layer 68, 70 is operable to at least partially contain portions of sharding debris from the substrate S. As illustrated in FIG. 8A, the first protective layer 68 and the second protective layer 70 may enclose the outer surface of each of the waveguides 18 of the stacked set of planar waveguides 50. In an embodiment, three or more planar waveguides 18 having the same or different substrates may be stacked and protected in this way.

In diffractive optics formed as diffraction gratings, increasing grating depth results in improved diffraction efficiency. However, increased diffraction efficiency in out-coupling diffraction gratings may reduce image-bearing light WO output from outer areas of the diffraction grating. Furthermore, embodiments containing multiple input gratings may generate an admixture of light beams, or crosstalk, within the waveguide. To compensate for these issues, FIG. 8A shows an embodiment wherein two planar waveguides 18 having substrates S1, S2, respectively, may be stacked together through a bonding process known by those skilled in the art.

The planar waveguide substrate S1 is coated on its upper plane parallel surface 15a with the substrate coating 28. Similarly, the planar waveguide substrate S2 is coated on its upper plane parallel surface 15 with the substrate coating 28. In an embodiment, the in-coupling diffractive features of the first and second substrates S1, S2 may effect image bearing light WI in different ways, such as diffracting only a certain spectrum of image bearing light WI into the respective substrates S1, S2 to propagate via TIR to the respective out-coupling diffractive optic ODO.

As illustrated in FIG. 8C, in an embodiment, the near-eye display system 12 includes a stacked waveguide system 126 mounted with an optics module housing 100. The stacked waveguide system 126 includes a first substrate S1 having an in-coupling diffractive optic IDO1 and an out-coupling diffractive optic ODO1, and a second substrate S2 having an in-coupling diffractive optic IDO2 and an out-coupling diffractive optic ODO2. In an embodiment, one or both of the substrates S1, S2 includes an intermediate optic. A projector 110 is located within the housing 100 and is operable to emit angularly encoded image-bearing light.

In an embodiment, the stacked waveguide system 126 is secured within the housing 100 with a distal waveguide fastener 106 and a proximal waveguide fastener 104. A plate 112 may be located within the housing 100 adjacent to the second substrate S1 such that the plate 112 is operable to provide structural rigidity to the waveguide system 126 located within the housing 100. The plate 112 is operable to reduce damage to the projector 110 during flexure of the stacked waveguide system 126. In an embodiment, additional plates 114, 116 are located adjacent to the first substrate S1 and the projector 100 such that the plates 114, 116 are operable to provide additional structural support to the stacked waveguide system 126. In an embodiment, the plates 112, 114, 116 are utilized to provide stiffness to the portion of the stacked waveguide system 126 located within the housing 100. In an embodiment, the plates 112, 114, 116 are mechanically secured to stacked waveguide system 126.

Quality testing and user handling patterns indicate that the most common point of fracture of the stacked waveguide system 126 occurs less than one centimeter from its point of connection with the housing 100. In an embodiment, the stacked waveguide system 126 includes a resilient flexure portion 128 and a generally rigid portion 140. As illustrated in FIG. 8D, the flexure portion 128 creates a resilient region operable to bend when a force is applied to the stacked waveguide system 126 in, for example, the z-axis direction. In an embodiment, the flexure portion 128 may be mechanically programed to fail under stress and/or fail under a stress which causes the substrates S1, S2 to flex beyond their bending point (e.g., twenty degrees).

To reduce sharding and maintain dimensional stability of the generally rigid portion 140, an abrasion resistant rigid coating 130 may be applied to the first and second substrates S1, S2. In an embodiment, the rigid coating encases the first and second substrates S1, S2 in the rigid portion 140 such that the coating surrounds the distal end of the substrates S1, S2. The rigid coating 130 may be composed of any number of hard, transparent polymers, such as Allyics, Polymethylpentene, Polycarbonate, and the like. In an embodiment, the rigid coating 130 may be applied over the protective layers 68, 70 as shown in FIG. 8A.

To further promote the structural integrity of stacked waveguide system 126, the first substrate S1 and the second substrate S2 may be separated by a gasket 73, a bead of adhesive, or other low durometer material operable to facilitate a space for the airgap 72, and allow for independent movement of the first and second substrates S1, S2 along the x-axis when flexed. In an embodiment, to avoid damage to the rigid coating 130 upon flexure, a substrate flexure channel 136 provides a cleft in the inner wall of the rigid coating 130 such that the planar waveguide substrate S1 and the planar waveguide substrate S2 independently displace when flexed.

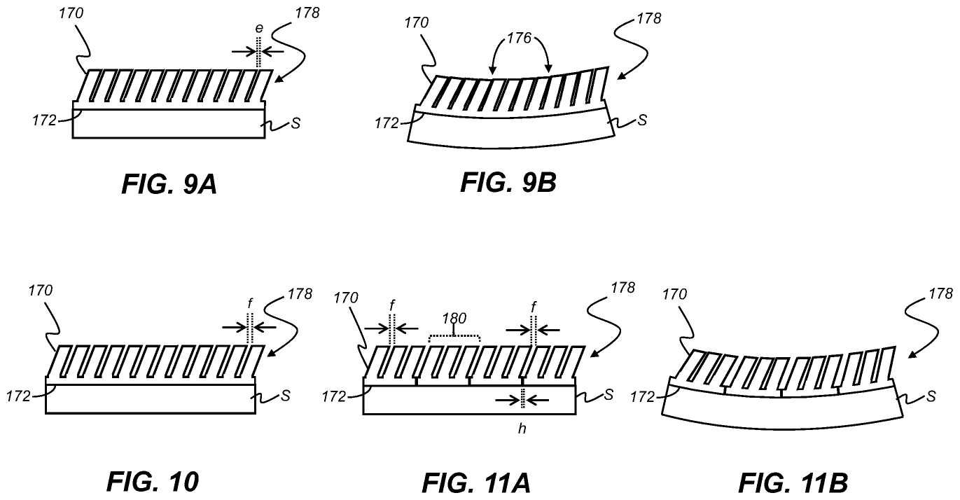

In embodiments of the present disclosure where the diffractive optics are not located in areas of the substrate(s) held rigid by, for example, coatings or backings/plates, the diffractive optics may be subject to damage during flexure of the waveguide/stacked waveguide system. FIG. 9A illustrates the unflexed orientation of an array of slanted surface relief grating features 170 formed in a coating 178 on a plane parallel surface 172 of substrate S. The grating features 170 are separated by a distance represented as spacing e. FIG. 9B illustrates some flexure of the substrate S, which may cause the abutting of delicate grating microstructures occurring at optical grating collision points 176, thereby risking damage to the functionality of the waveguide system.

As illustrated in FIG. 10, in an embodiment, to compensate for flexure of the substrate S, the grating features 170 have an expanded grating feature spacing f.

As illustrated in FIG. 11A, in another embodiment, the grating features 170 are separated into discrete sections, or grating strips 180, by grating strip spacings h. Each grating strip 180 contains a number of grating features 170. The limited overall surface contact of each grating strip 180 with the substrate surface 172 reduces the flexure required of the coating 178, thereby reducing the risk of delamination of the coating 178 from the substrate S. Each grating strip 180 is separated by grating strip spacing h. Grating strip spacings h may be accomplished by, without limitation, adhering each individual grating strip 180 to the substrate S or separating the grating strips 180 by micro laser ablation. FIG. 11B illustrates flexure of the coating 178, wherein the grating features 170 of separate grating strips 180 do not contact one another.

In an exemplary embodiment, a wearable display apparatus includes an electronics module operable to mount an optics module adjacent to a head of a viewer; a projector located within the optics module, wherein the projector is operable to generate image-bearing light beams; a waveguide coupled with the optics module, wherein the waveguide includes a substrate formed from a transparent optical material having a first surface located opposite a second surface, an in-coupling optic operable to direct the image-bearing light beams into the waveguide, and an out-coupling optic operable to direct the image-bearing light beams from the waveguide and to form a virtual image within an eyebox, wherein the virtual image appears at a distance in a field of view of the viewer; wherein the waveguide includes a first end and a second end, wherein the first end is coupled with the optics module, and the second end is operable to flex relative to the first end.

In an embodiment the optics module surrounds less than fifty-percent of a periphery of the waveguide.

In an embodiment, a first polymeric layer is coupled with the waveguide first surface, wherein at least one of the in-coupling diffractive optic and the out-coupling diffractive optic is located in the first polymeric layer.

In an embodiment, the waveguide second end is operable to displace relative to the waveguide first end at a twenty-degree angle, and the first polymeric layer is operable to flex without delaminating from the waveguide.

In an embodiment, the waveguide furthers includes an adhesive promotor on the waveguide first surface, wherein the first polymeric layer is adhered to the an adhesive promotor. In an embodiment, the waveguide further includes a second polymeric layer located on the first polymeric layer, wherein the second polymeric layer is operable to contain at least a portion of waveguide fragments where sharding occurs.

In an embodiment, the waveguide comprises an alkali compound, and the second end of the waveguide is operable to flex without breakage at least zero-degrees to twenty-degrees relative to the first end of the waveguide.

In an embodiment, wherein the waveguide is a first waveguide, a second waveguide is coupled with the first waveguide, and an air gap is located between the first waveguide and the second waveguide. In an embodiment, a low durometer material is located between the first waveguide and the second waveguide, wherein the low durometer material at least partially defines the air gap and is operable to flex with the first waveguide and the second waveguide.

While various embodiments have been described in detail above, it should be understood that they have been presented by way of example, and not limitation. It will be apparent to persons skilled in the relevant arts that the disclosed subject matter may be embodied in other specific forms, variations, and modifications without departing from the scope, spirit, or essential characteristics thereof. The embodiments described above are therefore to be considered in all respects as illustrative, and not restrictive. The scope of the invention is indicated by the appended claims, and all changes that come within the meaning and range of equivalents thereof are intended to be embraced therein.

What is claimed is:

1. An image light guide for conveying a virtual image, comprising:
a waveguide having a first surface and a second surface opposite said first surface;
an in-coupling diffractive optic formed along said waveguide, wherein said in-coupling diffractive optic is operable to direct image-bearing light beams into said waveguide; and
an out-coupling diffractive optic formed along said waveguide, wherein said out-coupling diffractive optic is operable to direct said image-bearing light beams from said waveguide toward an eyebox;
wherein said waveguide comprises a first portion and a second portion, and said second portion is operable to flex relative to said first portion.

2. The image light guide according to claim 1, wherein an optics module surrounds less than fifty-percent of a periphery of said waveguide.

3. The image light guide according to claim 1, further comprising a first polymeric layer coupled with said waveguide first surface, wherein at least one of said in-coupling diffractive optic and said out-coupling diffractive optic is located in said first polymeric layer.

4. The image light guide according to claim 3, wherein said waveguide second portion is operable to flex relative to said waveguide first portion at a twenty-degree angle, and said first polymeric layer is operable to flex without delaminating from said waveguide.

5. The image light guide according to claim 4, further comprising an adhesive promoter located on said first surface, wherein said first polymeric layer is adhered to said adhesive promoter.

6. The image light guide according to claim 1, wherein said waveguide comprises an alkali compound, and said second portion of said waveguide is operable to flex at least one to twenty degrees relative to said first portion of said waveguide.

7. The image light guide according to claim 1, wherein said waveguide is a first waveguide, a second waveguide is coupled with said first waveguide, and an air gap is located between said first waveguide and said second waveguide.

8. The image light guide according to claim 7, further comprising a low durometer material located between said first waveguide and said second waveguide, wherein said low durometer material at least partially defines said air gap and is operable to flex with said first waveguide and said second waveguide.

9. The image light guide according to claim 1, wherein said out-coupling diffractive optic comprises multiple sections of diffractive features, wherein a space is located between each said section of diffractive features.

10. The image light guide according to claim 7, wherein at least one of a first portion of said first waveguide and a first portion of said second waveguide is at least partially located within an optics module comprising an image-bearing light source; and wherein said first portion is connected with said optics module via a first fastener and a second fastener.

11. The image light guide according to claim 10, further comprising a plate coupled with said first or second waveguide between said first fastener and said second fastener, wherein said plate is operable to provide rigidity to said first portion of said first waveguide and/or said first portion of said second waveguide.

12. The image light guide according to claim 10, further comprising a rigid coating located about said second portion of said first waveguide and said second waveguide, wherein said rigid coating is operable to prevent flexure of said second portion; and said image light guide further comprising a third portion of said first waveguide and said second waveguide located between said first portion and said second portion, wherein said third portion is operable to bend.

13. A method of manufacturing a flexible image light guide, comprising:
providing a substrate having a first surface and a second surface opposite said first surface;
subjecting said substrate to an ion diffusion method;
coating said waveguide first surface with a first polymeric material; and
molding at least one of an in-coupling diffractive optic and an out-coupling diffractive optic in said first polymeric coating;
wherein said substrate comprises a first portion and a second portion, and said second portion is operable to flex relative to said first portion.

14. The method of claim 13, further comprising subjecting said substrate to a thermal treatment after said ion diffusion method.

15. The method of claim 13, wherein said ion diffusion method comprises immersing said substrate in a first molten salt bath at a first temperature range, whereby material of said waveguide first and second surfaces is compressed.
